(19) United States
(12) Patent Application Publication
(10) Pub. No.: US 2025/0166075 A1
(43) Pub. Date: May 22, 2025

(54) SYSTEMS AND METHODS FOR ASSESSING RISKS RELATING TO PRIVATE INVESTMENTS AND QUALIFYING INVESTORS AND AGENTS

(71) Applicant: Reserved Asset, LLC, Wilmington, DE (US)

(72) Inventor: David Kranz, Boca Raton, FL (US)

(73) Assignee: Reserved Asset, LLC, Wilmington, DE (US)

(21) Appl. No.: 18/949,442

(22) Filed: Nov. 15, 2024

Related U.S. Application Data
(60) Provisional application No. 63/600,330, filed on Nov. 17, 2023.

(51) Int. Cl. G06Q 40/06; G06F 16/904

(52) U.S. Cl. CPC G06Q 40/06; G06F 16/904

(57) ABSTRACT

Systems and methods for stakeholders in the financial services sector relating specifically to private investments and ways to assess the risks and benefits of such investments, the systems including methodology for aggregating data associated with potential investors, their financial advisors, and the private investment opportunities themselves to assess the suitability of potential investments for potential investors in an industry lacking transparency and public information. The systems and methods further provide additional data, information, and transparency for dealmakers and community collaboration and networking opportunities to share and monetize access to private investment opportunities.

### FIELD OF THE INVENTION

The present invention relates to the field of financial services, and more specifically to a system for assessing private off-market investment opportunities and simultaneously qualifying potential investors' suitability for such investments and financial advisors' experience and knowledge to facilitate such investment recommendations.

### BACKGROUND OF THE INVENTION

The statements in this section merely provide background information related to the present disclosure and may not constitute prior art.

The rise of the internet, and with it an exponential increase in connectivity, has strongly shaped the modern financial industry. With this newfound connectivity, Registered Investment Advisors (“RIAs”), Financial Firms and Broker Dealers (“BD”), collectively (“Firms”), can provide access to help investors buy and sell an array of investment products, accompanied by world-class analysis and personalized portfolio advice. However, while many public financial products are widely accessible and transparent, many private off-market investments remain opaque, illiquid and difficult to analyze. These realities create challenges for Firms to manage both the suitability of client's private investments, in view of each of their clients' and investors' (collectively “Clients) unique needs, risk profiles, and the like, and simultaneously manage the suitability of a Financial Advisor, Register Representative, and Investment Advisor Representative (collectively “Advisor”), in view of his or her experience and knowledge, both of the underlying investment and of the investor, to provide proper analysis and recommendations.

Private, off-market investments carry substantial risks that public investments do not. It has accordingly long been a challenge for Firms to manage the suitability of private off-market investments. In recent years there have been platforms developed that allow for easier access to investment in and knowledge of private investments, investment opportunities, and off-market deals (collectively, “Deals”). But these solutions continue to lack reliable assessment and suitability features and standards capable of indicating suitable Clients and Advisors with the appropriate skill levels to evaluate the suitability of each private Deal on a deal-by-deal basis.

Currently most Firms only even attempt to account for the risk and suitability of a private Deal for a Client. And many fail to adequately do even that. Because Firms do not often communicate directly with an Advisor's Clients, leaving those communications to each individual Advisor's direct management and judgment, Firms have no way of adequately assessing and determining if a private investment is suitable for a Client's specific needs. This knowledge-gap becomes more pronounced when dealing with private investments due to the lack of transparency, and the Firm must accordingly take on the enhanced risk that non-public information can be missed, which will affect the suitability of the private investment for all parties involved.

Many Firms attempt to fill this knowledge-gap by keeping client and investor data in a centralized, shared database for use firm-wide. But these solutions do not provide real-time alerts and feedback and most of these solutions rely on an Advisor to collect and share the data and information with the system, leaving them vulnerable to malfeasance, oversight, and simple human error.

Moreover, there has never been a solution that also simultaneously seeks to measure the risk and capabilities of the Advisors associated with a private investment and their capability to accurately assess and measure their own experience and understanding of the appropriateness of each off-market investment for each Client as well as the data, known or sometimes unknown, about the Client. Indeed, often knowledge of what an Advisor doesn't know but needs to know to assess a private investment opportunity is more impactful than the information that is known, and an Advisor's experience in dealing with certain forms of private investments often goes a long way toward knowing what questions to ask.

Indeed, Firms have often struggled to appropriately gauge the skill, knowledge, and intentions of the associated Advisor and ensure he or she has suitable experience in each specific private investment product. Likewise, certain compensation arrangements can create conflicts, and Firms need to assess the likelihood that the Advisor is acting in the best interest of the Clients (which are under the umbrella of the Firm), rather than exclusively in the Advisor's own best interests.

Once a Deal is approved at the Firm level, the Firm has to trust that the associated Advisor(s) are acting in the Clients' best interests, have experience assessing each specific type of private investment that they recommend, have a deep understanding of their Clients' financial needs, including what private investments are suitable for any particular Client, and have the proper incentives aligning them with their Clients' interests. This is further exacerbated by the somewhat low barrier of entry to become an Advisor in many U.S. jurisdictions and a lack of automated, updated oversight. These realities open Firms to heightened levels of liability and risk.

Firms' inability to automate assessments, restrictions, and alerts in connection with private investments, or at the very least to accurately assess the suitability of such investments from both a Client and Advisor perspective, presents a liability for the Firm which has previously been deemed as a cost of doing business. The solution to date has been purely reactive. Firms only learn about the unsuitable matching of private investment, Client, and Advisor after something goes wrong and there has been a complaint. This has been a core issue with private investment management to date.

For example, the following exemplary scenarios present situations where a certain private investment was unsuitable, and the Firm should have known it was unsuitable in advance, but only became aware at the point where potential liability had arisen:
A private investment with little liquidity was sold to an older wealthy Client, but placed in their IRA retirement account. Although this is a suitable investment for the Client, the Advisors limited knowing and understanding of the investment's liquidity caused the Client to not be able to access funds for their required minimum distributions (RMD).
An Off-market Investment in Real Estate was recommended to a suitable Client and purchased within their IRA. Because the Advisor didn't understand that this was not an appropriate investment to hold in an IRA as the leverage on the real estate property would cause the Client to have to pay UBTI taxes, even if it is held within their IRA.
A private investment in real estate debt which is a highly taxed investment was placed in a Client's taxable account versus a retirement account for a Client who is in a high tax bracket.
A speculative private investment with the risk of losing the total investment was sold to a Client who could afford the investment, so it seemed suitable, but wasn't in a position to take on principal risk due to a pending divorce.
A suitable private investment was sold to a Client, but because the Client owns real estate outside of the Advisor's Firm, this investment increased the Client's allocation in private real estate beyond what the Firm deems to be suitable exposure.
An Advisor sold a real estate investment to a suitable Client, but didn't understand the high internal fee structure of the product and it was sold to a Client who is very fee sensitive.
An Advisor sold a private investment in Oil and Gas, but because the Advisor never had experience in Oil and Gas, the Advisor didn't properly explain that the Client could be personally liable for any damages from the Investment, which extends to the Client's own personal assets beyond this investment. When there was an accident creating liability, the Client had personal liability on the claims.
Client with a high taxable event had the ability to access private investment that can offer tax shelters, but the Advisor presented other Deals in similar sectors that didn't offer the same tax benefit structure.

In each case, at first glance an unseasoned Advisor can easily think that a specific private investment is suitable for a Client, but the lack of understanding and experience to the particular Deal structure, taxes, leverage, fees, sector risks, etc. can provide an extensive misalignment of suitability for each Client. Firms' current inability to track and assess such potential for failure in advance in each instance ultimately creates extensive liability for the Firm.

There is currently no comprehensive market solution to effectively assist with managing private investments accordingly. While other solutions have tried, they typically assess and manage at best a single aspect of the risk profile associated with a private investment, that of the Client, and do so poorly. Accordingly, there remains a significant need for a financial system or instrument capable of managing private investment opportunities to avoid the liability associated with unsuitable investments.

There is also a shortcoming in the financial services industry with respect to how a Chief Investment Officer (“CIO”) and/or a Private Investment Creator, Manager, or Sponsor (collectively, “Sponsor”) can optimally structure a private investment opportunity to match the needs and suitability of what Firms, Advisors, and Client's need. Currently, a Sponsor and CIO has to structure a Deal, create investment terms and features, commit resources to strategy, and document development, operations and sales all prior to raising funds in hopes that Firms, Advisors, and Clients will be attracted to the Deals. Many decisions are made by the Sponsor or CIO in advance of raising capital such as fees, fund structures, liquidity, etc. These choices can reduce and limit the suitability of the private investment for Firms, Advisors, and Clients without the Sponsor or CIO knowing why.

The Sponsor and CIO also have little visibility into whether any terms can be adjusted to prompt more interest, and how much additional investment interest every adjustment within their current fund structure could actually prompt. There accordingly remains a significant need in the financial services industry for systems and methods capable of providing superior transparency on initial interest in private investment opportunities and how to structure a fund to maximize the suitability of Clients and their Advisors who have interest in investing provided that certain terms are included in the investment structure.

Finally, there is significant incentive to explore private investments given the potential returns. However, most funding of private investments occurs behind the scenes currently, with the Sponsor or CIO of a fund seeking out known advisors or investors and offering the private investment only to these known Firms and customers. Private investment thus often becomes compartmentalized and reliant upon Sponsor, CIO, Firm and Advisor's personal network, which can limit the investment potential both in amounts and number of Clients and in the quality or fit of the Clients that become aware. There is thus a need for a way to expand the private investment field to be more accessible to newer Firms and Advisors currently outside of large networks and, accordingly to more Clients.

Currently there are some open platforms that provide access to private Deals, but they are generally limited to the private investment opportunities presented by that specific platform-in other words, these platforms are effectively operating as Sponsor or CIO. This does little to facilitate a more open and accessible playing field revolving around private investments, as Firms, Advisors and their Clients are limited to investing in only the private investments available through those platforms, and access to those platforms is likewise often limited, through membership or access fees, network contacts, access to capital, and the like.

Furthermore, Advisors and their Clients need to have a level of trust for that particular platform's (or Sponsor's) own due diligence and Deal structuring activities. This often creates a binary relationship between the platform and the Advisors and their Clients. Most such platforms also charge fees to the Advisors for access or require some other form of compensation, which often limits the Advisors that can reasonably justify paying for access to those platforms. Such fee/compensation structures also may create undesirable incentives for Advisors and conflicts of interest, as the platform may obtain an initial financial benefit to everything Client invests in these private investments, regardless even of the success of the Deal, making it difficult for the Advisor to fully trust that each Deal presented on the platform is as attractive as the due diligence suggests.

No such platforms currently operating in the financial services space allow Firms, Advisors, CIOs and Sponsors to post their own private investment opportunities such that other users of the platform, be they Firms, Advisors or Clients, can see or assess the opportunities for themselves. There thus remains a need in the financial services industry for a social community access platform where sharing and collaboration between Advisors in the private investment space is possible, and where compensation is made available to the Advisor bringing the Deal to the platform, rather than to just the platform itself.

### SUMMARY OF THE INVENTION

It is accordingly the object of the present invention to resolve these shortfalls in the financial services industry. It is an object of the present invention to provide systems and methods capable of assessing all important factors, as applies to Firm, Advisor, Client, CIO and private investment itself, associated with private investments to avoid unsuitable outcomes that often result in liability. It is an object of the present invention to assess the suitability of Clients as potential investors in private investment opportunities, taking into account their ongoing financial needs, goals, current investment portfolios, risk profiles, etc. It is an object of the present invention to assess the suitability of Advisors as pertains to recommending and managing a private investment opportunity and which Clients it is suitable to present to. It is an object of the present invention to assess the private investment itself and its unique features to facilitate the knowledge Advisors and the system needs to assess the suitability of Clients and their Advisors.

It is an object of the present invention to offer Firms a means to track and manage the suitability of the Client, the Advisor, and the private investment simultaneously in real time. It is an object of the present invention to offer Sponsors and CIOs of private investment funds information and transparency as to what will qualify Clients and Advisors to access certain private investments, allowing the Sponsor or CIO to alter the terms of the opportunity to broaden its appeal and to target marketing towards those Clients and Advisors most likely to bring successful investment. And it is an object of the present invention to provide a platform allowing for collaboration and interaction among Firms, Advisors, CIOs, Sponsors, and Clients in the private investment sector that results in compensation for the Firm, Advisor, CIO or Sponsor who sourced the private investment.

To properly assess the three core, independent but interconnected input profiles of Client, Advisor, and Deal, the present invention preferably utilizes a data matrix employing a multi-criteria analysis approach to evaluate and compare different suitability options, both quantitative and qualitative, given the infinite number of possibilities created when assessing these three input profiles simultaneously.

The present invention employs the data matrix platform, preferably through a web-based interface and/or mobile application, to enable Firms to manage the three core components of suitability: Client, Advisor, and Deal. The present invention preferably runs hundreds of simulations using numerous data points regarding each of the three core components to determine the suitability of any particular private investment proposal. Utilizing a proprietary “suitability matrix,” the present invention preferably assesses each of the potential Clients, Advisors, and Deals and applies a “suitability score” to each. The present invention then preferably runs simulations to assess the likelihood of success in combining those three factors and applies a suitability score to the Deal as a whole. Though default settings are preferably available, a Firm can also preferably define its own standards based on its own risk tolerance and the like. In either case, the present invention provides the Firm with a system for assessing the risks associated with a Deal using the three core components of investment, Client, and Advisor.

The present invention preferably contains data on thousands of variables provided by certified public accountants, estate attorneys, certified financial planners, quantitative analysts, investment analysts, and the like to provide thousands of data points on private investment Deals from a multitude of sectors, including real estate, debt, oil & gas and other natural resources, land, senior housing, venture capital etc. Additional sectors will be known to those of skill in the art, and the present invention's technology is equally applicable to each such sector, as will be apparent to those of skill in the art.

The present invention also preferably tracks the results of its own suitability assessments and the results of private investments to fine tune its assessment as more and more data is gathered, learning from assessments that both accurately and inaccurately predicted successful and unsuccessful private investment outcomes as well as data regarding private investment outcomes that the present invention did not previously assess. Preferable embodiments of the present invention also learn from successful outcomes that proved to be unsuitable for other reasons and can update the assessment algorithms and criteria based thereon, creating a system that gets better and better at predicting suitability the more Deals it assesses. Firms employing the present invention may also preferably add data criteria and inputs and customizations, adjustments, and enhancements to fit their own suitability standards, risk tolerance, customer data, and the like, and the present invention will preferably automatically incorporate those customizations in real time and adjust its own learning and assessment algorithms accordingly.

Preferable embodiments of the present invention also perform an assessment of and apply a suitability score to the private investment, preferably taking into account factors such as liquidity, minimum investment amount, the fund manager's experience and personal stake in the investment, income, fees, and many others. These data points are preferably available for use to create the private investment's suitability profile and to allow the Sponsor of such private investments to assess a Firm's Client and Advisor compatibility and alter, in real-time, the fund's particular features and structure to make the investment more attractive and suitable to more people, accomplishing certain objectives of the present invention.

The private investment profile data and suitability assessment provide the Sponsor with information on what Clients want and what Firms and Advisors look at in assessing the suitability of Client and Advisor for an investment, which allows the Sponsor to modify their offering to allow for more Advisors and Clients to qualify. The Sponsor is then able to capitalize on this data, in preferable embodiments, by structuring private investment opportunities in a way that maximizes the private investment interest with each Firm. These features of the present invention also provide the Sponsor insight into what Firms, Advisors and Clients will have the most investment interest and allow each Sponsor to maximize their resources to concentrate their fundraising on those with the highest investment potential, improving the efficiency and transparency in what has, to date, been an opaque and inefficient process based primarily upon verbal communication.

Preferable embodiments of the present invention also incorporate collaborative, social-networking features for sharing information regarding private investment opportunities with and pitching known private investment opportunities to other Firms, Advisors and their Clients, accomplishing certain objectives of the present invention. Preferable embodiments of the present invention provide a collaborative space where private investment opportunities may be posted, discussed, and even amended in some preferable embodiments. The present invention also preferably provides access to historical information and performance of Firms and Advisors who have brought Deals in the past, allowing users to track each other's performance to assist in the due diligence process. In some preferable embodiments, the present invention allows for invite only, private networks amongst associated Firms, Advisors, CIOs and the like who are comfortable with one another and the experience and knowledge they bring to the table, allowing users to personalize the experience provided by the present invention. This allows users to access a broad array of private investment Deals and to specifically provide access to other users, such as Firms or Advisors known to have Clients interested in a particular private investment sector or type, Clients known in private investment circles, and the like.

Preferable embodiments of the present invention also provide the Firm, Advisor, CIO, or Sponsor who brings private investment opportunities to the collaborative community to receive direct compensation from other Firms, Advisors, and Clients they bring into the Deals through the collaborative environment. Such compensation may be fees associated with the Deal, in some preferable embodiments, and may be provided by those users who gained access to the Deal through the platform, from CIOs or Sponsors of the Deal, from the platform itself in fee collection embodiments, etc.

Users of the present invention can determine their own level of transparency and Deal accessibility they are willing to provide, the criteria that qualifies other users from seeing Deals they bring to the platform, etc., in some preferable embodiments. Such features cultivate the creation of smaller, collaborative networks within the broader network of the present invention. Those of skill in the art will recognize the benefits and attractiveness of such an environment to both Sponsors and CIOs of private investment opportunities and Advisors and Firms aware of and willing to share such opportunities amongst the other users of the present invention.

As those of skill in the art will appreciate, the present invention is not limited to the embodiments and arrangements described herein. Other objects of the present invention and its particular features and advantages will become more apparent from consideration of the following drawings and detailed description of the invention.

### BRIEF DESCRIPTION OF THE DRAWINGS

FIG. 1 is a schematic depiction of certain aspects of preferable and exemplary embodiments of the present invention.

FIG. 2 is a schematic depiction of certain aspects of the preferable and exemplary embodiments of the present invention depicted in FIG. 1.

FIG. 3 is a schematic depiction of certain aspects of the preferable and exemplary embodiments of the present invention depicted in FIGS. 1-2.

FIG. 4 is a flow diagram depicting certain aspects of the preferable and exemplary embodiments of the present invention depicted in FIGS. 1-3.

FIG. 5 is a schematic depiction of certain aspects of the preferable and exemplary embodiments of the present invention depicted in FIGS. 1-4.

FIG. 6 is a schematic depiction of certain aspects of the preferable and exemplary embodiments of the present invention depicted in FIGS. 1-5.

FIG. 7 is a schematic depiction of certain aspects of the preferable and exemplary embodiments of the present invention depicted in FIGS. 1-6.

FIG. 8 is a depiction of certain data employed within the preferable and exemplary embodiments of the present invention depicted in FIGS. 1-7.

FIG. 9 is a schematic depiction of certain aspects of the preferable and exemplary embodiments of the present invention depicted in FIGS. 1-8.

FIG. 10 is a schematic depiction of certain aspects of the preferable and exemplary embodiments of the present invention depicted in FIGS. 1-9.

FIG. 11 is a schematic depiction of certain aspects of the preferable and exemplary embodiments of the present invention depicted in FIGS. 1-10.

FIG. 12 is a schematic depiction of certain aspects of the preferable and exemplary embodiments of the present invention depicted in FIGS. 1-11.

FIG. 13 is a schematic depiction of certain aspects of the preferable and exemplary embodiments of the present invention depicted in FIGS. 1-12.

FIG. 14 is a schematic depiction of certain aspects of the preferable and exemplary embodiments of the present invention depicted in FIGS. 1-13.

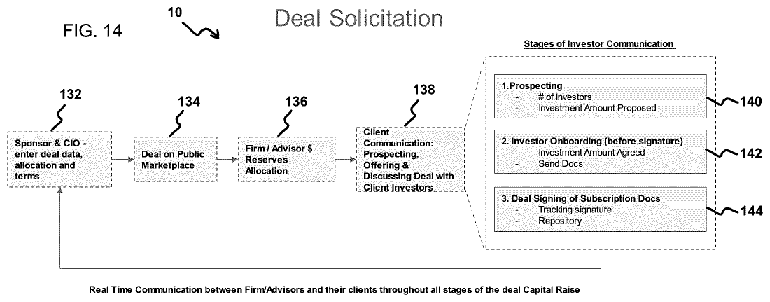

FIG. 15 is a schematic depiction of certain aspects of the preferable and exemplary embodiments of the present invention depicted in FIGS. 1-14.

FIG. 16 is a schematic depiction of certain aspects of the preferable and exemplary embodiments of the present invention depicted in FIGS. 1-15.

FIG. 17 is a schematic depiction of certain aspects of the preferable and exemplary embodiments of the present invention depicted in FIGS. 1-16.

### DETAILED DESCRIPTION

The following detailed description illustrates the invention by way of example, not by way of limitation of the principles of the invention. The description will enable one skilled in the art to make and use the invention and describes several embodiments, adaptations, variations, alternatives, and uses of the invention, including what is presently believed to be the best mode of carrying out the invention. Those skilled in the art will recognize alternative features, variations, and arrangements, and the present technology is not limited to those embodiments described hereafter.

A private off-market investment refers to an investment opportunity that is not available to the general public and is not traded on a public exchange. Instead, it involves direct investment in privately held companies, real estate, or other assets. Because it is not public, there is limited information that a Client can access online, or on their own, to fully understand the financials, duration, liquidity, fees, tax status, and risks. The majority of such information is provided to the Client by an Advisor whom the Client needs to trust personally, who understands the product, and who is acting in the Client's best interest.

Such private investment Deals may include direct investment in an individual private investment opportunity or investment through a fund or other collective investment vehicle. Private investment Deals cover a wide array of investment assets and opportunities, including without limitation privately held companies, including through venture capital enterprises and private equity funds, private debt and credit, distressed debt, collateralized debt, private company debt, warrants, and options, energy investments, including oil and gas exploration, clean energy technology, and carbon credits and exchanges, mineral royalties and other land lease investments, real estate, including without limitation multi-family, development, senior housing, mobile homes, storage, office space, cellular towers, data and server farms, land, commercial, retail, billboards, and advertising, student housing, single-family and rentals, etc., easements, and other alternative private investments, such as litigation finance, revenue backed debt, royalties, infrastructure, machinery, lease backing, opportunity zone funds, Delaware statutory trusts (DST), life settlement, non-publicly traded assets, etc.

Limited access is one key feature of private investments, which are typically offered to a select group of individuals. They are not available via public platforms like stock exchanges, and participation is often by invitation or through personal connections. Private, off-market investments thus offer a level of exclusivity since they are not widely known or accessible. This exclusivity can sometimes provide unique investment opportunities that may not be available through traditional channels, so Clients may be asked to pay more for access to these vehicles. This exclusivity also comes at the cost of much higher risk, generally speaking.

Private investments also significantly feature a fundamental lack of liquidity. Unlike publicly traded investments, which can be bought or sold easily on an exchange, private investments often involve a longer holding period and limited opportunities to sell the investment before a predetermined exit event, such as the sale of a real estate development, an initial public offering (IPO), or an acquisition. Many private investments also have longer lock-in periods, meaning that investors cannot easily access their funds for a specific period of time. This illiquidity can make it challenging to exit the investment if circumstances change or if investors need to access their capital urgently. Assessing the suitability of such investments requires careful consideration of one's financial goals, liquidity needs, and risk tolerance.

Accordingly, private investments are typically offered to accredited investors. These individuals are expected to have a certain level of financial knowledge and experience to evaluate the risks associated with such investments. Unfortunately, existing standards do very little to bar unsuitable investors from sophisticated and risky dealmaking. To meet the requirements to be an accredited Investor, one simply needs to have over $1 m in investable assets or have made over $200 k over the last two years. This qualifies most Americans in their retirement and most successful young adults who are just starting a successful career, but without much savings.

Combining the potential lack of sophistication with the limited information often associated with private investments creates a significant risk profile. Private investments generally lack the same level of transparency and regulatory oversight as public investments. Detailed information about the investment opportunity, its financials, underlying assets, and risks may not be readily available or easily accessible to the general public or a potential investor. Investors may need to rely on limited documentation, private placement memoranda, or discussions with investment managers, making it harder to thoroughly assess the risks involved.

Private investments also often involve complex structures, such as limited partnerships, special purpose vehicles, or alternative investment funds. These structures may have intricate terms, legal agreements, or financial arrangements that require a deep understanding to evaluate properly. Investors may need expertise in specific investment strategies or alternative asset classes to navigate the complexities effectively. In addition, private investments, especially those in emerging or non-traditional sectors, may have limited historical performance data available for analysis. This lack of historical information makes it harder to evaluate the investment's track record, assess its potential risks and returns, and compare it with other investment options. Investors may need to rely on qualitative factors, market trends, and the reputation of investment managers when making decisions.

Investing in private off-market opportunities thus also requires thorough due diligence. Since there is limited public information available, investors need to conduct in-depth research and analysis to understand the investment's potential risks and rewards. This often involves evaluating the management team, the business model, financial statements, and other relevant factors. It's important to note that private off-market investments carry a higher level of risk compared to publicly traded investments. The lack of liquidity, limited information, and potential for higher volatility can make these investments more suitable for sophisticated investors who have a higher risk tolerance and a longer investment horizon. Additionally, regulatory requirements for participating in private investments can vary across jurisdictions.

All these features of private investments result in a complicated risk profile and assessment even for the most seasoned Advisor with in-depth knowledge of his or her Clients' financial health, needs, risk tolerance etc. The present invention seeks to enhance this knowledge and provide each of Firm, Client, and Advisor with the additional tools necessary to help manage private investment opportunities.

The Suitability Matrix created by preferable embodiments of the present invention seeks to clearly define specific characteristics that are crucial for evaluating investment, Advisor, and Clients and assess the same, providing reliable feedback and recommendations on suitable private investment opportunities with a reasonable likelihood of success for each underlying Client. These characteristics include thousands of variables and data points, such as risk level and risk tolerance, potential return and financial goals, liquidity and financial needs, etc. all simultaneously to provide the most thorough suitability assessment available in real-time.

Each assessed factor's relative importance and weights may be based on predefined measurement scales, which may be default values recommended by the present invention's algorithms but are also preferably adjustable by Firm, Advisor, or Client based on each's own preferences, risk tolerance, etc. Preferable embodiments of the present invention also employ machine learning to adjust these factors and their associated weight based on the accuracy of past assessments as time progresses.

For example, the present private investment may have provided a suitability score predicting a high likelihood of failure for a potential Deal involving a private investment, Client, and Advisor the present invention viewed as unsuitable. In a scenario where such investment was engaged anyway and the outcome was successful, the present invention will preferably look back on its own recommendations to assess why it was incorrect and adjust the applicable factors appropriately. Likewise with respect to a Deal the present invention assessed as suitable that ultimately failed. Aggregated over tens of thousands of assessments and Deals, this machine-learning will improve the functionality of the suitability matrix and render the recommendations from the present invention highly reliable and applicable.

Preferable embodiments of the present invention use the proprietary formula employing machine learning and artificial intelligence to forecast the suitability of Deals, formulate the suitability standards, and make recommendations to assist in the decision-making process. Some preferable embodiments of the present invention also incorporate public information about other known private investment opportunities, known successes and failures, etc. into its algorithm and assessments in real-time. Such preferable embodiments may employ web-scraping functionality, allow the input of such information manually, or any combination thereof or involving other methods known to those of skill in the art.

Preferable embodiments of the suitability matrix used by the present invention involve no less than three core criteria-a suitability code applicable to the Advisor, a suitability code applicable to the Client, and a suitability code applicable to the private investment. The Advisor suitability code assesses the Advisor's knowledge, experience, and readiness to promote certain private investment opportunities. In some preferable embodiments, an Advisor's suitability code will affect the Deals he or she is provided access to through preferable embodiments of the present invention's user environment. Likewise with respect to the Client and investment suitability codes.

For example, an Advisor who has extensive knowledge in real-estate sector private investments but has never been involved in an oil & gas investment opportunity may not even see oil & gas opportunities through the present invention's user environment, in some preferable embodiments. Some preferable embodiments may also allow an Advisor or Client to turn off or not show investment opportunities in sectors they are not comfortable in, etc. As will be plain to those of skill in the art, there is no limit to the manners in which the present invention can be implemented by users to personalize and improve the user experience.

Preferable embodiments also assess the investment options that are suitable for each Client to match Clients only with private investments that fit their particular goals and needs and Advisors capable of facilitating the Client's participation therein. The present invention preferably analyzes Client data beyond just risk tolerance and the like. As an example, a Client may not receive a positive recommendation for a particular private investment if the Client is already over-allocated to a particular sector, the minimum investment is too high, the capital will be locked up for too long, etc. Those of skill in the art will recognize additional factors that may render what would normally be a suitable private investment opportunity unsuitable for a particular Client's needs.

Preferable embodiments of the present invention's suitability matrix aggregate the Advisor, Client, and private investment suitability codes to generate an overall evaluation and suitability score for each private investment option for each Client and associated Advisor. Some preferable implementations of the present invention will only allow Deals that adhere to a Firm's acceptable suitability range, as may be established by the Firm and updated from time to time based on new inputs, assessments, and information, whether manually applied, the product of machine-learning or artificial intelligence, or the like. Those of skill in the art will recognize the flexibility and applications of the suitability score and recommendations the present invention generates thereby.

What the Advisor has access to view through the present invention's user platform may also impact, and be impacted by, what is suitable for said Advisor's Clients. For example, the present invention may determine that a private investment is suitable for a particular Client, but if that Client's Advisor does not have the requisite experience, knowledge, and expertise in that sector, the Advisor may not be presented that private investment opportunity as an option. Likewise, an investment that a particular Advisor has sufficient expertise to manage may not be presented as an option if it is not suitable for any of that particular Advisor's Clients, and so on.

There are countless combinations of data that could influence the suitability between Client, Advisor, and private investment that can't be measured by traditional weighting or matching functions even if the Deal appears suitable. For example, a private real estate investment that provides cash flow of 6% a year but is illiquid might be appropriate for an Advisor to recommend to an elderly Client who needs income, but not the same elderly Client if they only have retirement accounts for investment capital and needs liquidity to make future required minimum distributions. Preferable embodiments of the present invention's suitability matrix would recognize this disconnect and would disqualify or recommend against this private investment opportunity for such Clients, as those skilled in the art will ascertain. And preferable embodiments grant Firms the ability to predefine and adjust, in real-time, such restrictions.

Preferable embodiments of the present invention also allow Firms to manage the Deals they will approve in real time. For example, preferable embodiments permit Firms to set mandatory approvals in advance and add overrides to prevent an Advisor from moving forward with a Deal that the Firm isn't comfortable with, for reasons of preselected criteria. Preferable embodiments of the present invention are designed to include protective stopgaps the Firm can manage in real time to avoid unapproved activities from associated Advisors and Clients.

Preferable embodiments of the present invention also provide Firms the ability to automatically set parameters and rules to control which Advisors can offer or otherwise engage in Deals based on those Advisors' suitability. Preferable embodiments also permit Firms to set parameters and rules to control which of its Advisors' Clients have the appropriate suitability to invest in each opportunity. Notably, investment opportunities within the same sector can also have different levels of complexity, which can affect the suitability score for Advisor or Client in connection with a given investment opportunity. The same Advisor who might qualify to be suitable to invest in one Deal within a sector might not have a high enough suitability score to qualify to invest in a different Deal within the same sector, where the second Deal is substantially more complex, for example.

Below is an inexhaustive list of the types of factors that preferable embodiments if the present invention consider to provide a deep understanding of the private investment and apply an investment suitability code:
1. Category—Defines the type of Asset for example, Real Estate, Private Debt, Oil & Gas, Private Companies, etc.
2. Financials—Target Returns, cash flow, cost and expenses.
3. Target income—All income and distributions along with the classification of thy type of income.
4. Fund manager background—History, experience and historic performance.
5. Fees—Includes all fund fees, commissions, administrative fees, and operating fees.
6. Tax guidelines—Type of tax structure and benefits.
7. Managers personal investment—Amount the fund managers are investing.
8. Duration—Length of fund.
9. Liquidity—How accessible and liquid the fund is at different times.

Below is an inexhaustive list of the types of factors that preferable embodiments if the present invention consider to provide a deep understanding of the Clients and apply a Client suitability code:
1. Age—Age of client will play a big factor on what private investments can be considered suitable.
2. Account Types—Personal Accounts, Retirement Accounts, Trusts, Corporate Accounts all provide different benefits and risk when holding investments.
3. Location—Location of the Investment can provide different tax breaks and costs depending on the location of the Client.
4. Family—A Client's family needs play a big intangible factor in private investment suitability.
5. Investment Experience—Experience of the Client with certain private investments.
6. Financial goals—Embodies all aspects that impact a Client financially including but not limited to income needs, liquidity needs, estate planning, taxes, and wealth accumulation, retirement goals, etc.
7. Life goals—additional homes, travel, future plans, aspirations.
8. Risk Appetite—Client's comfort with risks and need of principle protection.

And below is an inexhaustive list of the types of factors that preferable embodiments if the present invention consider to provide a deep understanding of Advisor knowledge and expertise and apply an Advisor suitability code:
1. Firm restrictions in place to manage risk—Suitability standards and limitations created to manage the Advisor access and to ensure each Advisor awarded access has the experience, understanding, and accurate knowledge of the underlying private investment and type of Clients that each investment will be suitable for.
2. Prior experience investing—Advisors experience both investing and working with private investment within a similar category.
3. Historical recommendations—Advisor's historic experience investing within certain sectors.
4. Type of clients—Types of Clients and an Advisor works with, i.e. High Net Worth, Business Owners, Retirees will all play a role in what types of private investments and Advisor should be able to recommend.
5. Years of Experience—Advisors years of experience as an Advisor and working in other industries.
6. Complaints—Historic complaints and infractions.
7. Size of business—Size of Firm often helps assess the sophistication and supporting infrastructure of an Advisor.
8. Location—Location of an Advisor can improve their knowledge of private investments within that area.
9. Performance—Historic performance of other private investments that Advisor's had recommended their Client's to participate in.
10. Incentives—Compensation structure.

The present invention preferably assesses each of these factors, and more that will be apparent to those of skill in the art, in ascribing suitability scores to each of the three core components. The present invention then preferably ascribes a suitability score to the combination of the three core components to indicate whether to expect a suitable or unsuitable investment matching outcome. In some preferable embodiments, the overall suitability score for a Deal may be on a spectrum, such as 1-10 or 1-100. In some preferable embodiments, the overall suitability score may simply comprise a pass or fail metric or a qualitative metric providing guidelines.

In some preferable embodiments, the present invention may automatically recommend against a Deal or even prevent the Deal from happening based on particular criteria, which may be included as a standard within the system or set by a Firm based on its own internal policies. Exemplary applications of such restrictions might occur in the case of a mismatch between Advisor knowledge and private investment, between Client and private investment, and the like. Those of skill in the art will recognize the various factors that might weigh in favor of preventing a private investment Deal entirely, or at least recommending against it.

Preferable embodiments of the present invention use algorithms and AI to provide rules and ideas for an infinite combination of Client and investment data points to provide the Advisors and Firms with important qualitative information that must be assessed when a private investment is in consideration for a Client. The present invention's algorithms and AI are preferably populated by accountants, CIOs, estate attorneys, CFOs, Firms, AI platforms, etc. to provide the qualitative information that both Firms and Advisors need and can use to further manage ongoing alerts and provide Client recommendations when discussing each private investment with each Client.

Preferable embodiments of the suitability matrix also assess the suitable investment amount for Clients and what accounts are most appropriate for the Client to hold the private investment in and provides additional crucial information to the Advisor that must be thought about or properly communicated to the Client. Preferable embodiments further provide Firms with the capability to track, manage, approve, restrict and assess each Advisor's actions and behavior in real-time in relation to each of their Clients' private investments while the suitability matrix facilitates a quantitative view of the investment, Client, and Advisor. Preferable embodiments further provide Firms with the capability to assess the suitable investment amount for each Client, what accounts are most appropriate for the Client to hold the investment in and provides additional crucial information to the Advisor that must be thought about or properly communicated to the client. Preferable embodiments further provide Firms with the capabilities to track, manage, approve, restrict and assess each Advisor's actions and behavior in real-time in relation to each of their Clients' private investments.

Preferable embodiments of the present invention also provide access to transparent, smart data regarding private investment opportunities and the participants therein. Access to such information about other Advisors and Clients invested in a Deal, such as their backgrounds, the amounts invested, percentage of capital held thereby, etc., may offer other Firms, Advisors and their Clients with additional insight into the quality of a private investment opportunity.

For example, knowledge of whether other investors in a Deal are sophisticated, are institutional or retail, their experience and success in other, similar private investments in the past, capital commitment amounts, track records of success, expectation of due diligence and analysis performed by known individuals, Advisors, or Firms, etc. may all provide further assurances to other potential Firms, Advisors, and their own Clients. For example, a $10,000,000 capital raise can be made by 200 unsophisticated retail investors each investing $50,000 for the first time, or it can be made by five larger investors that have committed $2,000,000 each, where they all have had extensive experience and success investing in other private Deals within this same sector. Such information fundamentally changes the perceived risk profile of such a private investment opportunity, and having that data at hand helps Clients to make more informed decisions and helps Advisors offer more complete and confident recommendations to their Clients.

The transparency provided by preferable embodiments of the present invention into other Clients and Advisors participating in a private investment Deal are multi-fold. Reputation and credibility of other investors in a Deal is significant in assessing an investment's likely success, thus enhancing its appeal. Those skill in the art and in the financial industry more broadly understand that certain individuals possess unique expertise, insights, or connections that have enabled their success. As a result, the investment opportunity gains credibility and becomes more enticing to others who aim to replicate their success when such individuals are also invested in the Deal.

Seeing other successful investors participating in a private investment can also provide a sense of validation for some Clients and Advisors. Investors may feel more confident about the investment's potential when they witness others with proven track records committing their capital to the opportunity. This validation can reinforce the perception that the private investment is exclusive and offers promising prospects.

In an exclusive setting, which most private investment opportunities operate within, the opportunity to network with other successful investors can also be very valuable in and of itself. Discussions and interactions with other successful private investors may provide access to insights, market intelligence, or additional private investment opportunities that are not widely available. Such privileged information can further strengthen the appeal of a private investment for both Advisors and their Clients.

And, despite the exclusivity and limited access to information generally associated with private investments, it remains crucial for Clients and their Advisors to conduct thorough due diligence. Careful evaluation of the private investment's fundamentals, risks, and alignment with personal investment objectives are necessary to ensure a private investment is a good fit and has a reasonably likelihood of success, measured both by potential gains and time horizon. Clients and Advisors should leverage their own knowledge and expertise to assess the private investment independently, and access to other investors in a Deal can provide additional insight and availability of information that might otherwise be unavailable.

Additional smart data also benefits the Sponsors and CIOs of private investment opportunities and others seeking to broaden the spectrum of suitable Clients in their private investment Deals. Preferable embodiments of the present invention provide insight to such Sponsors and CIOs to assess and modify the limiting features of a private investment opportunity, which can operate to entice a more diverse field of Clients and their Advisors.

Indeed, factors such as investment liquidity, minimum investment amount, expected income, fees, and management experience and contribution can all disqualify certain investors or make an investment less attractive thereto. Providing that suitability information to Sponsors and CIOs structuring a Deal at the onset offers them the opportunity to make changes, often small or incremental, that will maximize the investment potential without any significant impact to profitability, investment success, etc.

Armed with information on what Clients want, dislike, and what may be non-starters allows CIOs and Sponsors to modify their offerings to allow for more Clients and Advisors to qualify under the suitability analysis employed by preferable embodiments of the present invention. Sponsors and CIOs are also granted the opportunity to capitalize on this knowledge by concentrating fundraising efforts on those Firms, Advisors, and Clients who qualify and are most likely to engage in and contribute to such Deals, increasing the pipeline to capital and efficiency and success of fundraising efforts.

Preferable embodiments of the present invention also include a collaborative, social-networking environment through which users of the system can interact directly, share knowledge and information about private investments, etc. This feature provides the ability for Firms and Advisors to share and discuss the Deals that they are investing in for their Clients, and potentially attract additional investors as well. Some preferable embodiments of the present invention also include the ability for the user sharing the Deal to restrict or permit access and visibility by other users.

Preferable embodiments of the present invention permit, for example, one Firm, Advisor, Sponsor, CIO, or Family Offices to associate with or “follow” another Firm, Advisor, Sponsor, CIO, or Family Offices to observe that user's activities on the platform. Once approved, the user being “followed” can choose to share or restrict, in preferable embodiments, the “following” user's access to invest in Deals they recommend, invest in Deals alongside them, view Deals they are investing in and the historic Deals they have invested in, the amounts that they invest in Deals (current and historic), their due diligence, their research, etc.

Firms, Advisors, Family Offices, and CIOs will also have the ability to negotiate fee splits with the Sponsors, in some preferable embodiments, which allows the Firms, Advisors, Family Offices, and CIOs to participate in the financial benefits that are normally only awarded to the General Partners of such Deals. Additionally, Firms, Advisors, and CIOs can negotiate additional fee splits with other Firms, Advisors, and Family Offices for contributing additional funds to their private investment.

Such preferable features allow Advisors to see and assess the track record of other Advisors and Clients, the amounts they are investing, how many Clients are investing, if an Advisor is investing personal money, along with visibility into Advisor's and Firm's previous success regarding the private investments they have participated in. This knowledge creates affirmation that they are getting access to private investment opportunities already involving others who have a track-record of success and creates a community network approach where users can work together, utilize each other's research, and receive compensation from other users who wish to get access to those individuals' data and Deals. And Firms, Advisors, Family Offices, and CIOs have the ability to post Deals as both the General Partner and a Limited Partner to raise funds.

Preferable embodiments of the present invention further allow CIOs and Sponsors to invite other Sponsors, Firms, Advisors, CIOs and Clients to view their private investment opportunities as well and monetize those interactions. Such contacts can then post their own Deals and invite others and so on, creating and growing a social network within the financial advisory industry, and specifically in the context of private investment where such is most needed and helpful. In some preferable embodiments, users can also restrict and/or limit who can see and access their data and Deals, creating smaller networks and partnerships amongst users and promoting collaboration within the industry that has historically been very isolated.

More specifically, a Firm or Advisor bringing a private investment opportunity to the platform provided by the present invention may wish to limit the other users who have access based on predefined criteria. Such criteria may include years of experience of potential collaborators in the industry, historical indices of success on private investment Deals generally or in a particular sector, or even limitations to specific users the Firm or Advisor has a prior relationship with or is comfortable working with. This functionality helps to cultivate smaller, private networks within the platform as a whole amongst users who like and feel most comfortable working together to the exclusion of other users. Firms and Advisors may also utilize preferable embodiments of the platform of the present invention for their own, private and individual purposes, e.g. to manage the suitability of their own Deals, Advisors, and Clients within their own Firm, without engaging with other users or the social networking component at all.

Users of such preferable embodiments of the present invention can also establish and/or join numerous network groups of varying sizes and share within each said group information in a limited or unlimited fashion, per user preference. Preferable embodiments also permit users to engage in direct messaging activities that can be associated directly with a private investment opportunity or user portfolio or that can be more generally conversational. Such direct messages may be restricted in the users who can view it based on network groups, investment opportunity, Firm, Advisor, Sponsor, CIO or Client identity, and any number of additional criteria. Indeed, at any given time, a user could have numerous direct messaging chains active with different groups within a single investment opportunity, for example.

Preferable embodiments of the present invention funnel each potential private investment opportunity through the suitability matrix to understand in advance the potential benefit of each Deal to the user, be it a Firm, Advisor, or individual Client. The present invention preferably analyzes Advisor, Client, and investment to identify in advance what Advisors, Clients, and total investment amounts will be suitable for each investment opportunity. Information on the number of qualified Advisors and each's qualified Clients, total investment dollar potential, and both the quantitative and qualitative benefits for accessing each Deal provides the user with up front knowledge of the max monetary potential and benefits of including each specific private investment opportunity offering within their Firm or portfolio.

Some preferable embodiments of the present invention also include an “audit package” that facilitates the accumulation and storage of data and information that might be needed should the Firm get audited. Due to the difficult nature of tracking suitability and billing Clients for private Deals, many Firms are audited by the SEC and FINRA. Such audits require the Firms to disclose information such as Client suitability reports, Advisor suitability, internal Firm processes, and disclosures regarding private Deals, documented due diligence on both the Deal and the Client, Client communications, fee structures, etc.

Preferable embodiments employing the audit package will preferably notify the Firm and Advisor if the Deal contains any inconsistencies that might be flagged in an audit or if any data specific to a Client, Advisor, or Firm itself is likely to cause issues if an audit is instituted. Such preferable embodiments preferably provide the audit package suitable for both SEC audits and FINRA audits, and preferably include all information that would be required for an audit in one organized location. Such information preferably includes due diligence, suitability matching efforts for both Client and Advisor in relation to each Deal, fee structures, investment disclosures, communications and dates, internal Firm processes and procedures, subscription documents, and the like. Those of skill in the art will understand the information that would potentially assist in audit proceedings, all of which is included in such preferable embodiments including the audit package.

Preferable embodiments of the present invention also provide unique features for identifying and engaging potential investors. Often, Sponsors and CIOs of an investment opportunity must spend time, money, and resources to educate Advisors, Firms, and Family Offices about the investment. The Advisors and Firms, then typically share that information with their Clients, and particularly with those for whom the private investment might be of interest. If the Firm or Advisor is interested or has clients it believes are/will be interested, the Firm or Advisor may make a commitment to the CIO or Sponsor to invest a predetermined amount within a predetermined timeframe. CIOs and Sponsors use these types of commitments to gauge interest in the private investment and assess the likelihood of meeting funding goals and the like.

However, the anticipated investments do not always come through in a timely manner and may not come through at all in some circumstances. Thus, the Sponsors and CIOs of the investment opportunities are often operating without a true, real-time understanding of the status of fundraising and investment in their Deals, lacking transparency on the status of communications between Firm/Advisor and Client and on the movement of Client funds in preparation for investment. This arrangement has numerous drawbacks.

First, it can create a false reliance from the Sponsor or CIO on the commitment from the Firm and Advisors, creating additional risk that funding goals will fall short. It can also cause the Sponsor or CIO to focus attention on following up with investors who agreed to invest, but have yet to sign any documents, rather than seeking new investors or alternative options. The lack of transparency into the status of an Investment can also cause the Sponsor or CIO to sell the agreed allocation to a different investor early due to not understanding when closing documents would be signed by the current Advisor's Clients. In many situations, investment opportunities have a capped investment amount, and once a portion of that amount is earmarked to a Firm or Advisor, the Sponsor or CIO will not typically seek another investor to fill that fundraising, so having expected funds fail to come through is problematic for the Sponsor and CIO, who may well lose the investment altogether as a result. This refers to circumstances where Firm and Advisor are unable to cover their commitments in full, and the Sponsor or CIO were caught off guard. These situations can all cause strained and broken relationship between Firm and Advisor with the Sponsor and CIO.

Preferable embodiments of the present invention thus include features that facilitate providing transparency to the Sponsor and CIO on the status of committed Advisor/Firm fundraising efforts. Such features preferably include tracking communications between Sponsor/CIO and Firm/Advisor and between Firm/Advisor and Clients. Such features also preferably include documenting commitments and real-time updates as to the status of fundraising to meet those commitments. Such features also preferably include tracking the Client prospecting process and tracking the status of Client onboarding and execution of necessary documents for their investment in each particular Deal.

Preferable embodiments make these features visible to the Sponsor or CIO of a Deal so as to provide transparency and real-time information that the Sponsor or CIO can use to assess the need for additional fundraising or the need to identify alternative investors. Sponsors and CIOs are preferably able to track commitments from Firms/Advisors, review and confirm Firms/Advisors are communicating with Clients and obtaining commitments of Client funds, and observe Client execution of documentation and availability of funds to finalize the process.

Preferable embodiments of the present invention also employ algorithmic machine learning and artificial intelligence features to assess and advise Sponsors and CIOs on whether particular Firms or Advisors are on pace to satisfy commitments in a timely manner, whether the Sponsor or CIO would be wise to follow up with committed participants, and even when the Sponsor or CIO should consider seeking alternative fundraising opportunities in anticipation that a particular Firm or Advisor appears unlikely to satisfy its commitment. In each case, the Sponsor and CIO enjoys additional transparency. In some preferable embodiments, the Firm and Advisor may be provided with options on what information to share, such as status information on a Client level or only cumulative information on the Firm or Advisor status more generally.

Some preferable embodiments of the present invention also provide a Reliability Score for Firms and Advisors based on their historical track record in following through on investment commitments. Because a Sponsor and CIO need predictability to effectively engage in fundraising for each specific Deal based on the investment goals and other factors, it is of paramount importance to have some assurance that a Firm or Advisor that commits to raising a certain amount toward an investment goal follow through on that commitment. The Firm or Advisor's failure to do so causes major problems for the Sponsor, CIO and the Deal. The Sponsors and CIOs accordingly must learn quickly who can and cannot be relied upon to follow through on commitments.

There is no currently effective way to track and establish a Firm's or Advisor's reliability in following through on investment commitments. Instead, Sponsors and CIOs are left to make decisions on who to work with based on their experience with specific Firms and Advisors personally, each's reputation, and the Sponsor's and CIOs intuition. Sponsors and CIOs are accordingly in need of additional useful features to establish the reliability of a Firm or Advisor, without which they are forced to favor established and known Firms/Advisors to the detriment of newer and unknown Firms/Advisors. This outcome harms the ability to reach fundraising goals in addition to negatively impacting new participants in private investment activities due to lack of trust.

Likewise with respect to the reliability of the Sponsor or CIO. For example, a Firm or Advisor might request the Sponsor or CIO hold a portion of the allocation being raised for a short time while engaging in due diligence. The Sponsor or CIO might agree to do so but then turn around and offer that allocation to another investor, leaving the initial Firm or Advisor without an opportunity to invest in the Deal upon completing its due diligence. Or a Firm or Advisor might even commit to an investment amount and the Sponsor or CIO turns around and sells that portion to another investor who can raise funds more quickly or the like. In both instances, the initial Firm or Advisor is left without an opportunity to invest in the Deal upon completing its due diligence and/or raising money from Clients, leaving the Firm's and Advisor's reputation in disrepair.

Some preferable embodiments of the present invention accordingly implement a Reliability Score for Sponsor, Firm, Advisor, CIO, Family Office and even Client, which adds a level of accountability and predictability to place all participants in the Deal in a better position. The Reliability Score preferably tracks the user's past involvement in Deals done on the platform, quantifies prior tendencies, and measures the likelihood of following through on representations made to other participants in a Deal.

The Reliability Score preferably incorporates hundreds of data points, including past performance, available funds, number of Clients, number of sponsored Deals, types of Clients, investment areas of experience and expertise, etc. The present invention utilizes this data to assign a Reliability Score to each Sponsor, CIO, Firm, Advisor, Family Office and even Client, in some preferable embodiments, which Score provides a level of accountability and transparency prior even to any written commitment by either side of a Deal.

Like the Suitability Score, the Reliability Score can be used by Sponsors and CIOs to limit which Firms, Advisors, Family Offices and Clients have access to specific Deals. It can be used by Firms to limit which Advisors and Clients are approved for investment in specific Deals and to limit the Deals available to invest in generally based on the Sponsor's and CIO's Reliability Score. It can be used by Advisors to limit which Clients have the opportunity to invest and to steer clear of Deals sponsored by unreliable Sponsors and CIOs. And finally, it can be used by Clients and Family Offices to assess interest in Deals, find preferable Advisors, and the like. In each case, the transparency added by the Reliability Score informs all parties on the potential pitfalls in making a Deal with the others.

The Reliability Score preferably digs deeper than simply assessing whether a participant followed through on a commitment. It preferably assesses failures to do so in depth: was it simply a question of timing, did a significant Client pull funds at the last moment, were the terms of the fundraising target changed by the Sponsor or CIO at some point, was enough prior notice provided to permit a Sponsor or CIO the opportunity to find alternative funding sources, etc.? Preferable embodiments of the present invention employ algorithmic machine learning and artificial intelligence to assess all such data points and assign an appropriate Reliability Score. This way, specific circumstances are factored into the calculations which can be more negatively impacted by more severe actions while at the same time not ruining a specific user's ability to do business on the platform is not ruined due to actions taken outside of its control.

Additional factors and data points utilized to determine Rliability Scores include: diligence by Firms or Advisors in communicating about the Deal with their Clients a; diligence in communicating potential issues to other participants in a Deal in a timely manner; earmarking Client funds and completing document execution and due diligence expeditiously; assessment of failures to meet commitments, including timing and fundraising shortfall, how quickly notice was provided, whether alternative options were offered or if Sponsor or CIO had time to find alternative investors; assessment of Sponsors' and CIOs' reliability in holding an allocation for an agreed upon time to allow the Firm or Advisor to perform due diligence on the Deal; communication of any changes in terms of fundraising; frequency and level of follow through; level of experience in Deals and related availability of data to assess; reciprocation and referral activities. As will be understood to those of skill in the art, this is but an exemplary list of the factors and types of data points that are used in the formulation of Reliability Scores.

Preferable embodiments of the present invention also facilitate negotiation between Sponsor and CIO with the Firm and Advisor. For example, a Sponsor may be looking to raise a $10 million investment and may set the minimum investment amount at $1 million and a maximum investment amount of $2 million per Firm or Advisor. A Firm or Advisor that has $500,000 in interest from clients might pass entirely on the opportunity, believing it cannot meet the minimum investment requirement. Likewise, a Firm or Advisor that is looking to invest $5 million might pass and look elsewhere.

In either case, the Sponsor or CIO might be willing to bend the rules in the right circumstances, but the Firm/Advisor may never know that, and the opportunity is lost. Or, at the very least, the Firm or Advisor would need to spend time identifying, contacting, and discussing with the Sponsor or CIO, and may ultimately still be unable to invest, reducing efficiencies in the investment system. Sometimes, a Firm or Advisor may not be comfortable with proceeding without additional due diligence, which may take more time than the investment opportunity remains available, again creating a lost investment opportunity.

Preferable embodiments of the present invention resolve these drawbacks in classic non-public investing by providing a convenient and direct line of communication between Sponsor and CIO with the Firm and Advisor. The present invention provides Sponsors and CIOs the ability to establish total investment targets, minimum and maximum investment thresholds, identify which Firms and Advisors that the opportunity will be available to, and to communicate discretely and directly thereon.

These features make any one-off arrangements between Sponsor and CIO with the Firm and Advisor far easier to negotiate, can provide the Sponsor and CIO with notification of a Firm or Advisors interest but failure to commit, providing the Sponsor and CIO the opportunity to reach out directly to negotiate alternate terms, and otherwise alter the terms of the Deal to maximize the ability to achieve fund-raising targets. Preferable embodiments of the present invention also employ algorithmic machine-learning and artificial intelligence to track the various successful Deals the platform facilitates to provide guidance to Sponsors and CIOs to set the terms of a Deal or alter those terms to be more likely to reach fundraising and other objectives (e.g., targeting large Firms and Family Offices rather than smaller Firms, single Client investors, etc.).

Preferable embodiments of the present invention further employ algorithmic machine-learning and artificial intelligence to identify and advise Firms on which Advisors and Clients are most suitable for an investment opportunity and Advisors on which Clients are most suitable for an investment opportunity, taking some of the risk out of private investing. Preferable embodiments of the present invention also permit Firms to place limitations on their own associated Advisors and Clients, as noted above, including limitations based on suitability or investment amount, and provide the ability for collaboration between Firm and Advisor/Client and between Advisor and Client, providing suitability information and assessment in real-time during such discussions.

Specific features available in preferable embodiments of the present invention include Sponsor's and CIO's ability to set total fundraising goals, maximum and minimum thresholds, noting either hard or soft thresholds, and to negotiation directly on alternative arrangements; Firms' ability to limit access to Advisors and Clients, set minimum and maximum investment limits for individual Advisors and/or individual Clients, offer alternate terms and negotiate alternate arrangements with Sponsors and CIOs, and request additional time for due diligence; Advisors ability to negotiate term limitations placed by Firm; Firms ability to negotiate term limitations placed by the Sponsor and CIO; and the use of algorithms and intelligent data to provide guidance on suitability, targets, and terms for each party to a transaction, including Sponsor, CIO, Firm, Advisor, Family Office and Client. These features are exemplary only, and other features will be recognizable to those of skill in the art, which can be included in preferable embodiments as well without diverging from the goals and implementation of the present invention.

Preferable embodiments of the present invention also include features to facilitate the relationship between Firm and Advisor with new Clients, investors, and Family Offices who desire increase access to specific types of investment opportunities. In the current private investment environment, Clients only typically become aware of private investment opportunities when their Advisor notifies them thereof and the Advisor is limited to only present investment opportunities that the Advisor and Firm have access to, regardless of whether it is the perfect investment for what the client needs.

The manner of introducing potential investor Clients to Advisors is also an area that could use additional resources. Often, Advisors reach Clients using marketing activities or other referrals. This arrangement may not connect a Client with an Advisor who has the access and knowledge to the most suitable private investment strategies for the Client's needs.

Preferable embodiments of the present invention solve these limitations by providing investors, typically high-net-worth (“HNW”) individuals, and families, with access to the platform, allowing them to view and identify private investment opportunities that best fit their needs, and then provides the HNW Individual and family with access to the Advisors who are experts-giving more power to the HNW investors when determining the most suitable Advisor to work with. For example, a Client may see a private investment opportunity that interests them, but their current Advisor does not have access and/or is not suitable to advise them on such a private investment opportunity, and the present invention can thus provide recommendations on alternative Advisor(s) the Client could contact who have access to the select Deal and specific knowledge of these types of private investments. Or perhaps the HNW investor does not have any Advisor currently, in which case preferable embodiments of the present invention could notify the investor of Advisors suitable for a specific investment opportunity the Client is interested in, or can even facilitate a general assessment of the Client's goals and provide Advisor/Firm recommendations based thereon, in some preferable embodiments.

Preferable embodiments of the present invention provide individualized access for Clients, Advisors, and Firms. Each can establish its profile/reputation, report investment activities and expertise, and market its services and size to one another, creating a symbiotic relationship between each participant in the private investment activity. No longer are Clients forced to rely on marketing or the luck of the draw when it comes to finding an Advisor that suits their needs. Clients can search for Deals posted by CIOs, Sponsors, and Firms directly; can search Advisors who are investing in certain Deals or investment areas; and can review a Firm and/or Advisor's history, bio, track record, and experience in various investment areas and industries. Clients can then directly facilitate a relationship with Firms and/or Advisors to meet their specific needs and desires based on transparent access to the information provided through the platform of the present invention, in preferable embodiments.

In some preferable embodiments, limitations can be implemented by the Sponsor and CIO of a Deal to prevent a Client from seeking to invest directly into a Deal, instead requiring such a Client to contact a Firm and/or Advisor approved by the Sponsor or CIO to invest in that particular Deal. Or the present invention may provide this service directly, in some instances, either by locking unsuitable Clients out of a particular Deal or making it invisible to such a Client. In some preferable embodiments, the Sponsor of a Deal can control this feature on a deal-by-deal basis, providing a targeted matching system between Client, Advisor, Firm, CIO and/or Sponsor. This process also provides a lead generation mechanism where experienced Firms and Advisors can attract more suitable Clients because of the Clients' interest in access to and experience with specific Deals and specific investment areas and opportunities.

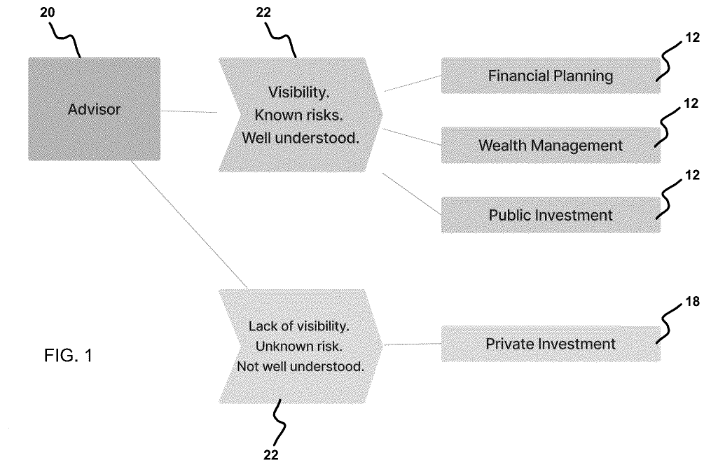

Referring now to FIG. 1, the experience of the Advisor 20 is depicted in schematic form. The Advisor 20 has far more predictability in traditional financial investment activities 12, such as public investment, wealth management, and financial planning, with plenty of transparency, visibility of known risks, and a generally sophisticated understanding of the assets 22. Meanwhile, when involved in private investing 18, the opposite has traditionally been the case, where the Advisor has the benefit of very little in the way of transparency, visibility of known risks, and thorough understanding of the nature of the assets 22. Naturally, this reality has made private investing 18 a far more risky endeavor for Clients 30 than traditional investing options 12.

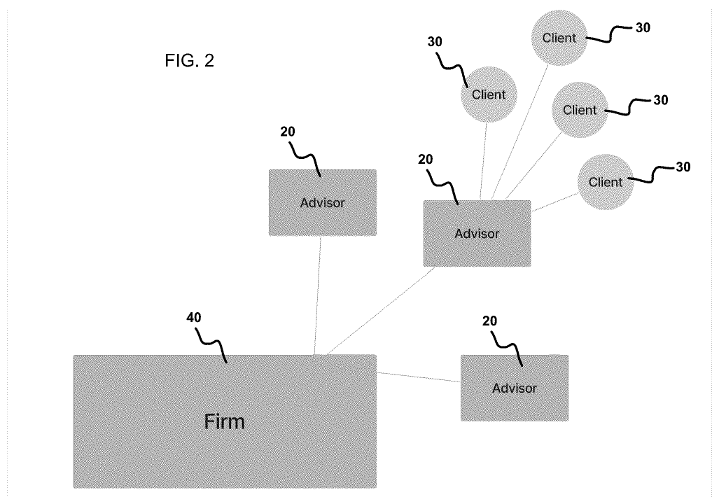

Referring next to FIG. 2, many Advisors 20 are part of a larger Firm or organization 40, which in many cases employs rules and guidelines to limit the risk undertaken by its team of Advisors 20. The Clients' 30 relationship is typically with one or more Advisors 20 rather than directly with the Firm 40 itself, and the Advisors 20 generally manage their Clients 30 within the confines of the rules set out by the Firm 40.

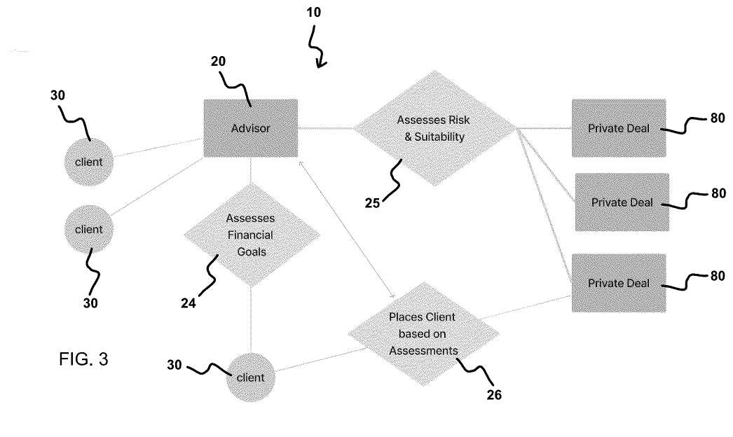

Referring now to FIG. 3, Advisor's 20 interactions and assessment of Clients' 30 needs utilizing the platform of the present invention 10 is depicted in schematic form. As shown, the Advisor 20 must assess the financial goals 24 of the Clients 30, including the Clients' risk tolerance and associated suitability 25 in connection with potential private investment Deals 80 and opportunities. As noted, the present invention 10 utilizes the data gathered by the Advisor 20 on the Client 30 to generate a “suitability matrix” 62 assessing what Deals 50 are appropriate and aligned with the Client's 30 goals and circumstances. The Advisor 20 can then use the platform of the present invention 10 to invest funds based on the assessment 26 generated for each Client 30.

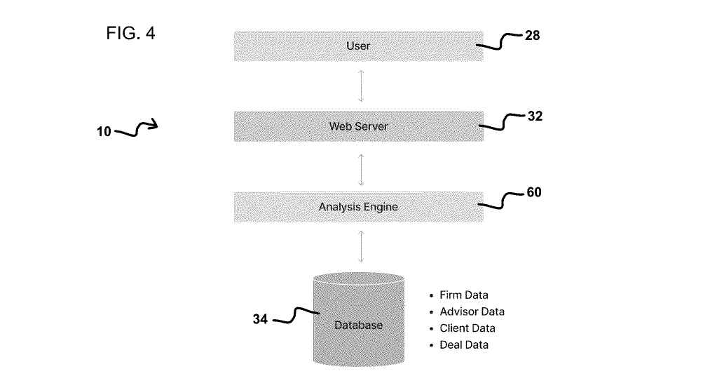

Referring next to FIG. 4, preferable embodiments of the system of the present invention 10 are shown with preferable features, including the analysis engine 60, web server 14, and database 16. The users 28 of the platform of the present invention 10 may include Advisors 20, Clients 30, Firms 40, Sponsors 50, CIOs 52, HNW investors, etc. Users 28 typically interact with the system of the present invention 10 through a web server 32, which electronically connects the users 28 to the analysis engine 60 and the associated database(s) 34. The database(s) 34 preferably contain information about all the Clients 30, Advisors 20, Firms 40, Sponsors 50, and Deals 80 using, connected with, and available on the system of the present invention 10.

The analysis engine 60 employs the algorithms, modules, and features that assist the users 28 in assessing the suitability of Advisors 20, Clients 30, and Firms 40 in connection with available Deals 80 as shared by Sponsors 50, CIOs 52, and other users 28. Preferable embodiments of the analysis engine include algorithmic machine learning and artificial intelligence features that improve the performance of the analysis engine 60 over time as additional data and analysis is obtained and performed thereby.

The suitability matrix 62, for example, is affected by numerous factors, including Client 30 needs, risk tolerance, and circumstances, Advisor 20 experience, expertise, and track record, Firm 40 resources, institutional experience and expertise, and track record, Sponsor 50 information, Deal 80 terms, and numerous other factors. As the data associated with these factors is obtained, stored, and accessed through the database(s) 34, the analysis engine 60 can improve . . . . Likewise, as the analysis engine assesses more and more Deals 80, Clients 30, Advisors 40, etc., it can provide more nuanced and effective analysis and advise for newly assessed Clients 30 and Advisors 20 in similar circumstances and Deals 80 with similar terms, Sponsors 50, etc.

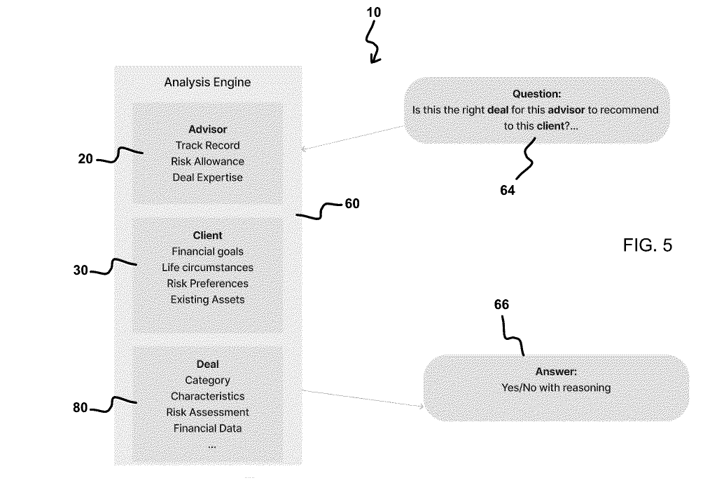

As depicted in FIG. 5, the analysis engine's 60 primary role is to assess whether a Deal 80 is right for recommendation by an Advisor 20 to one or more of the Advisor's 20 Clients 30 or not 64. In answering this question 66, the analysis engine employs the techniques and features discussed above, including formulation of a suitability matrix 62 for Advisor 20 and Clients 30 based on data associated therewith and with the Deal 80 itself. An Advisor's 20 track record, risk allowance, and Deal 80 expertise and experience are considered; the Client's 30 financial goals, life circumstances, risk tolerance, and assets are assessed; and the Deal's 80 terms, risks, area of investment and category of asset(s), and financial characteristics and data are all a part of the analysis. As the analysis engine 60 gets more and more experience assessing suitability of Deals 80, Advisors 30, Clients 20, etc., it grows more and more effective in its assessments and performance.

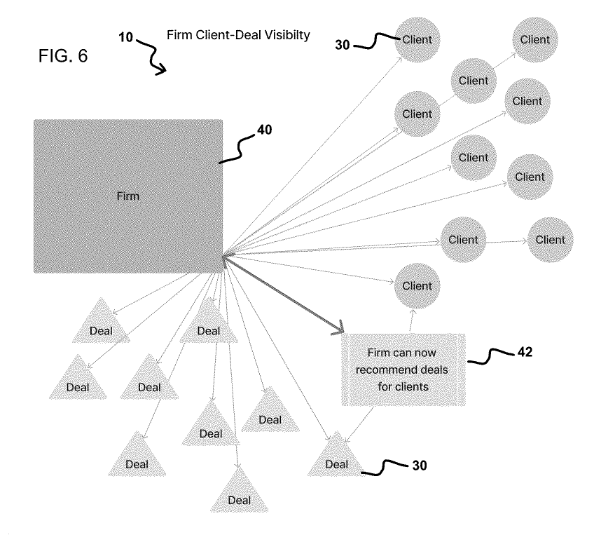

Referring now to FIG. 6, the Firm 40 interactions with Clients 30 concerning potential Deals 80 on preferable embodiments of the present invention 10 is depicted. In the case of institutional expertise and activities performed by a Firm 40, generally in addition to those more personal interactions between Advisors 20 associated with the Firm 40 and their Clients 30, preferable embodiments of the present invention 10 facilitate the direct interaction between Firm 40 and Client 30 by which the Firm 40 can make recommendations, float Deals 80, and otherwise provide institutional advice 42.

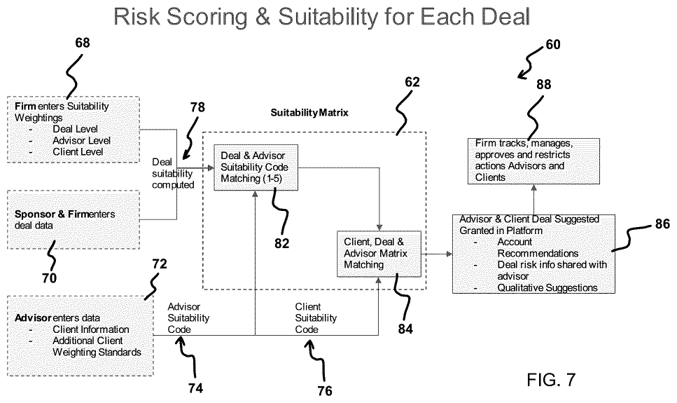

Referring next to FIG. 7, preferable embodiments of the activities performed by the analysis engine 60 of the system of the present invention 10 are depicted. As reflected, the Firm 40, Advisor 20, or Client 30 directly in some circumstances, can set parameters 68, such as a Deal's 80 risk or complexity level, an Advisor's 20 experience level and areas of knowledge, a Client's 30 experience investing in private Deals 80, risk tolerance, etc. The analysis engine 60 can also import other factors relating to the Deal 80 and its terms, its Sponsor(s) 50, etc. 70. Finally, the analysis engine 60 can obtain additional data about Advisor 20 and Client 30 circumstances and assesses any disqualifying factors 72, such as an investment that would tie up funds for a Client 30 with required minimum distributions. As will be understood to those of skill in the art, these factors are exemplary only and are optional inputs in preferable embodiments.

The analysis engine 60 preferably generates an Advisor suitability code 74, primarily based on the Advisor's knowledge and experience in connection with Deals 80 of the nature being assessed, and a Client suitability code 76, primarily based on the Client's circumstances, risk tolerance, and investment goals, and feeds the Advisor suitability code 74, Client suitability code 76, and Deal suitability code 78 into the suitability matrix 62, where the suitability matrix 62 applies a score matching the Deal and Advisor suitability codes 82 and a score matching the Deal, Advisor, and Client suitability codes 84 to generate its recommendations 86. The analysis engine 60 generates its recommendations 86 and provides them to users 28 of the system of the present invention 10, primarily including the Advisor 20 and Firm 40, and in some circumstances the Client 30 and/or Sponsor 50 as well, involved in the associated Deal 80.

The analysis engine's 60 recommendations 86 preferably include an assessment of the suitability of the Deal 80 for the Client 30, including any disqualifying factor, recommendations on whether to pursue the Deal 80 or not, any assessed risks associated with the Deal 80, whether resulting from the Client's 30 circumstances, the Advisor's 20 experience and expertise, or otherwise, and any qualitative suggestions to make the Deal 80 more attractive or investable. The analysis engine's 60 recommendations 86 may be further processed and assessed in view of other Deals 80 available, other Clients 30 associated with an Advisor 20, other Advisors 20 and Clients 30 associated with a Firm 40, and in connection with past and future assessments and recommendations 86. Preferable embodiments also provide Firms 40, Advisors 20, and/or other investment managers and users to track, approve, restrict, or alter the restrictions applicable to associated Clients 30 and Advisors 20 in some circumstances 88.

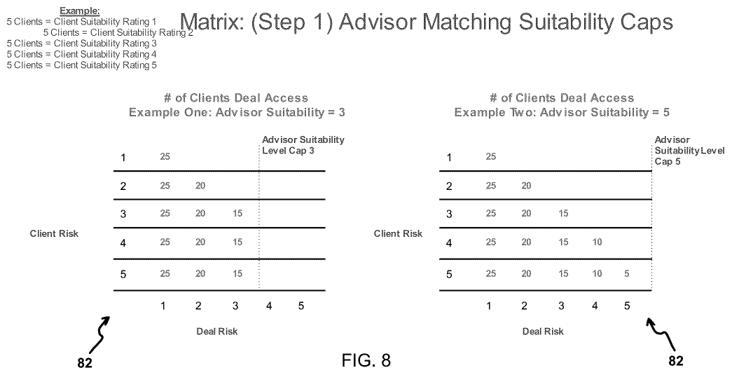

Reflected in FIG. 8 are exemplary analysis engine 60 outputs associated with matching the Deal and Advisor suitability codes 82 as part of the suitability matrix 62. As reflected, the suitability matrix 62 incorporates the Deal suitability code 78 and the Advisor suitability code 74 to assess the list of the Advisor's 20 Client's 30 for which the Deal 80 might be recommendable. In the examples reflected in FIG. 8, one Advisor 20 has an Advisor suitability code 74 of 3, which caps the Deals 80 available to Clients 30 at risk level 3, while the other Advisor 20 has an Advisor suitability code 74 of 5, removing any restrictions in the Deals 80 available to Clients 30 on the basis of the Deal suitability code 78 and associated risk levels.

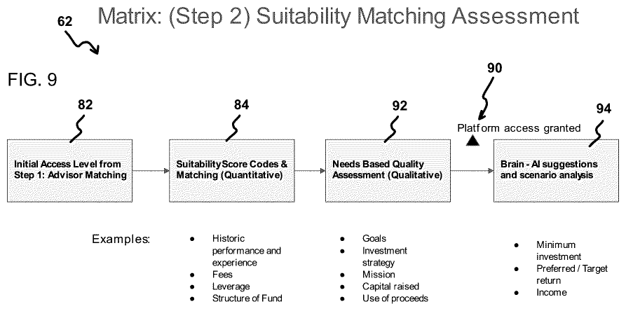

Referring now to FIG. 9, the suitability matrix 62 next matches the Deal, Advisor, and Client suitability codes 84 to generate and finalize its recommendations 86 on which Clients 30 a particular Deal 80 is or is not suitable for. As depicted, the analysis engine 60 first obtains the results of its matching of the Deal and Advisor suitability codes 82 and applies any restrictions or risk level caps applicable to the Advisor 20 based on the Advisor suitability code 74. The suitability matrix 62 then incorporates the factors affecting individual Clients 30 in order to generate recommendations 86 at the Client 30 level.

The Client 30 level analysis preferably employs a quantitative analysis 84 matching all three of the Deal, Advisor, and Client suitability codes 74, 76, 78. As a part of this quantitative analysis 84, preferable embodiments consider historic performance and experience of those associated with the Deal 80, fees and structure of the Deal 80, and particular circumstances of the Client 30, such as levels of leverage, nature and amount of assets, circumstances, etc. The suitability matrix 62 also preferably employs a qualitative analysis 92 of the Deal 80 in light of the Client's 30 stated investment goals, strategy, and mission, available capital, intended use of earned income, etc., which information would have been obtained from the Client 30 before the Client 30 is granted access 90 to the platform and system of the present invention 10.

The analysis engine 60 of the present invention 10 then preferably employs the algorithmic machine learning and artificial intelligence features and techniques to run scenario analyses and assess potential outcomes 94 as a final step in assessing the suitability of the Deal 80 for the Client 30. The results of these analysis steps are then preferably reflected in the recommendations 86 generated by the suitability matrix 62 and incorporated into future iterations of machine learning and artificial intelligence features and techniques.

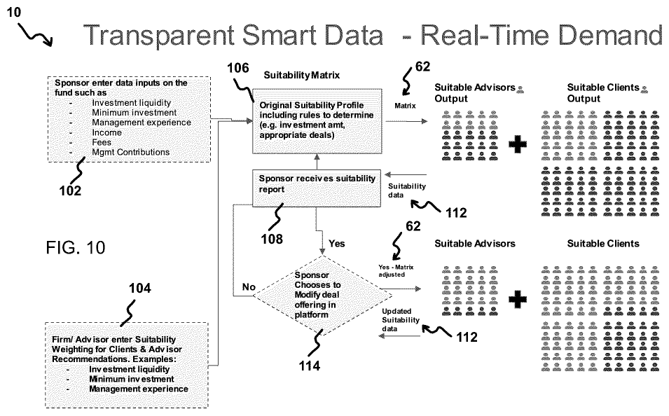

Referring next to FIG. 10, features of the system of the present invention 10 are depicted indicating the population of suitable users in connection with terms set for a Deal 80 by the Sponsor 50. In this example, the Sponsor 50 can set the terms and enter data associated with the investment opportunity 102, including liquidity considerations, minimum and maximum investment levels, any income generated by the investment, fees associated with the investment, Deal managers experience, expertise, and personal investment exposure, etc. A Deal term weighting process 104 may be employed by Advisors 20, Firms 40, or Clients 30 in some preferable embodiments.

The data is then provided to the analysis engine 60, which generates a suitability profile 106 for the Sponsor's 50 proposed Deal 80 terms, which is reflected in the suitability matrix 62 applicable to the Deal 80. The Sponsor 50 obtains the suitability matrix 62, Deal suitability data 112 and report 108, and can then modify the Deal terms 114 to make the Deal 80 more available to more Advisors 20 and Clients 30, assisting in the Sponsor's 50 fundraising efforts.

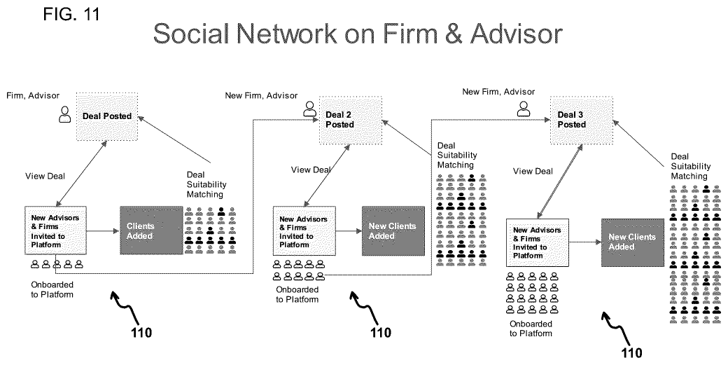

As reflected in FIG. 11, the system of the present invention 10 preferably employs social networking, messaging, and interaction features to assist the users 28 in reaching more Deals 80 that satisfy all parties' requirements. As Sponsors 50 add new Deals 80 to the system, and as Firms 40, Advisors 20, and Clients 30 share those Deals 80 and their involvement therewith, the user-base grows and additional investment opportunities and investors will become available, as depicted in the example suitability reports 110 reflected in FIG. 11.

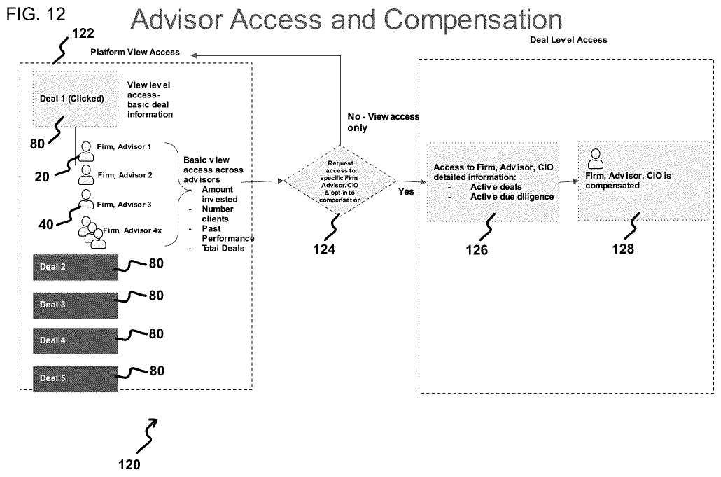

Referring next to FIG. 12, a preferable embodiment of the present invention 10 employing a compensation module 120 is depicted. For example, as depicted in the preferable embodiment of FIG. 12, an Advisor 20, Firm 40, Sponsor 50, or really any user 28 of the platform 10 can access a list of Deals 80 that he or she is involved with 122. Said user 28 can choose to share that information 124 with other users, including any due diligence, details about the Deal 80 of the user's 28 participation therein, etc. Other users 28 may then gain access to that information 126, either as a member of the system at large, as a member of a specific group of approved users 28, or in exchange for compensation 128, in some preferable embodiments.

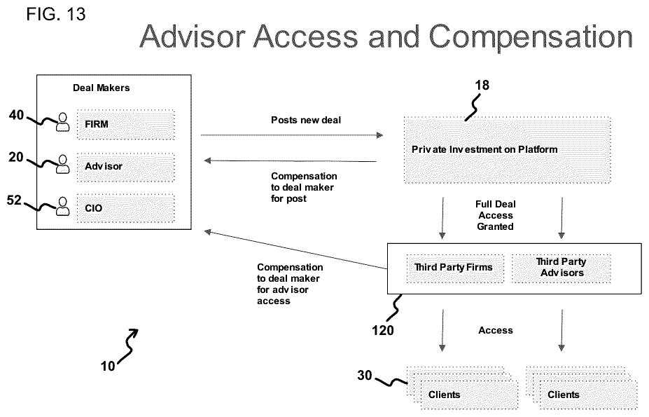

Referring now to FIG. 13, the compensation module 120 may also compensate those who bring new opportunities and Deals 80 to the system 10 for the attention and investment by others. An Advisor 20, Firm 40, or CIO 52 might post a new Deal 80 for private investment 18, may obtain compensation in exchange for bringing the Deal 80 to the platform 10 and/or for permitting users 28 access to additional info, due diligence, etc. Said access may be compensated by other Advisors 20 and Firms 40, who can then share that Advisor-level info with their own Clients 30, increasing the investment pool and improving access to private investment opportunities 18 for users 28.

Preferable embodiments of the present invention 10 can also be utilized to improve access to investors for Sponsors 50 and CIOs 52 looking to reach funding targets for a Deal 80 and to improve transparency associated with the funding process. The Sponsor 50 provides the terms for the Deal 132 and posts those to the platform's 10 public marketplace 134. Advisors 20, Firms 40, and/or Clients 30 receive notification of the availability of a Deal 80 and the terms thereof and can reserve a portion of the allocation 136.

At this point, some of the fundraising target is earmarked for that reserve 136, and those funds become unavailable for alternative investors. Accordingly, the Sponsor has a vested interest in ensuring the Advisors 20, Firms 40, and/or Clients 30 who reserve a funding amount follow through on that reservation, and the present invention 10 offers transparency in preferable embodiments by sharing communications among Advisors 20, Firms 40, and/or Clients 30 with the Sponsor 50 so they can follow along with fundraising progress 138 and even review discussions regarding number of Clients 30 the Advisor 20 or Firm 40 is offering the Deal 80 to and the amount available for investment 140, confirmations from Clients 30 of interest and actions taken to clear capital 142, and even observe signing of documentation and other activities to perfect participation 144.

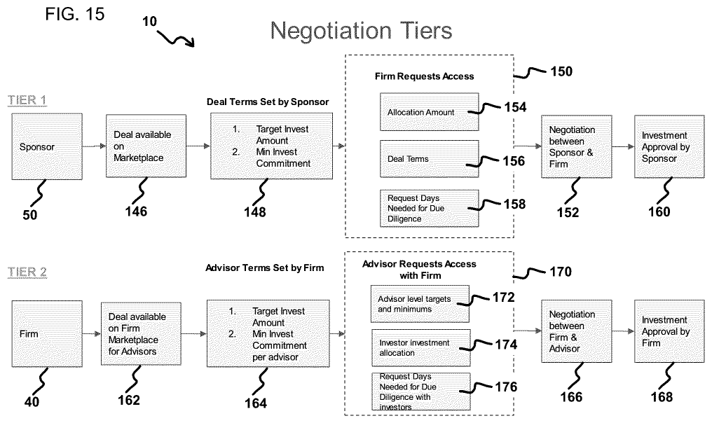

Referring now to FIG. 15, preferable embodiments of the present invention 10 include features for facilitating negotiation between Deal 80 Sponsor 50 and/or CIO 52 and potential investor representative, whether Advisor 20, Firm 40, or even Client 30 in some circumstances. For example, once a Deal 80 is posted to the platform 146, if the terms set by the Sponsor 148, such as minimum or maximum investment, do not align with the Client's 30 needs, the Advisor 20, Firm 40, or Client 30 themselves may seek to contact the Sponsor 50 to change the terms or request an allowance or otherwise negotiate investment terms 152 that are acceptable to both sides.

Preferable embodiments may require Sponsor's approval of Firm 40, Advisor 20, or Client 30 before access to the negotiation platform 150 is permitted. Once the Firm 40, Advisor 20, or Client 30 is granted access to the negotiation platform 150, information about the Deal 80 terms will typically be available for review/discussion 156, the parties to the negotiation can discuss an allocated amount 154 for the Firm 40, Advisor 20, or Client 30, particularly when requesting an investment allocation outside of the terms set by the Sponsor 148, the Firm 40, Advisor 20, or Client 30 can request a hold period during which time it can perform due diligence 158, etc. Once the negotiations are finalized, the Sponsor can approve of the investment 160 and allocate the funds.

The system of the present invention 10 also preferably provides a negotiation platform 170 for Advisors 20 to request additional permissions or authorization from their Firm 40. In preferable embodiments, the Firm 40 will add a Deal 80 to the list available 162 to its Advisors 20, which list the Firm 40 may control for risk, investment area, or other factors, and set terms for each individual Adviser 164 based on said Adviser's 20 experience and expertise, etc. The Adviser 20, upon receiving access to the negotiation platform 170, can access and request changes to targets and minimums 172 the Firm 40 has set for the Advisor 20, restrictions on investment levels and allocations 174 to the Advisor's 20 Clients 30, request due diligence time 176, etc. Upon engaging the Advisor 20 in negotiations over the limits and restrictions 166, the Firm 40 can decide whether to approve or reject the request 168.

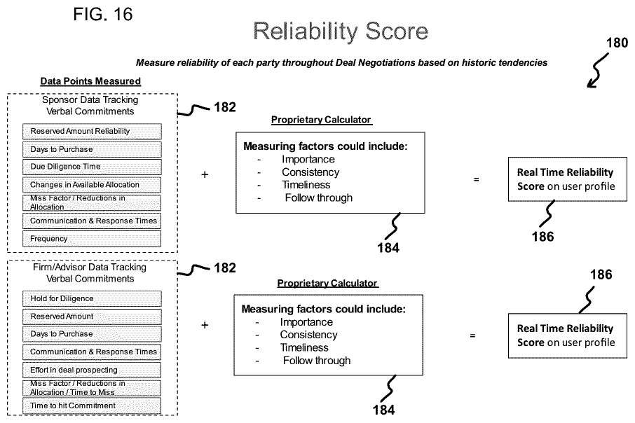

Referring now to FIG. 16, preferable embodiments of the present invention 10 also employ a Reliability Score feature 180, providing transparency and predictability to users 28 about Clients 30, Advisors 20, Firms 40, Sponsors 50, CIOs 52, etc. The Reliability Score feature 180 preferably tracks data about users 28 and their track record 182 in following through on commitments, providing accurate and timely communications, etc.

More specifically, data tracked about Sponsors 50 preferably includes track record in allocating funds when a Firm 40, Advisor 20, or Client 30 commits, providing a reasonable amount of time to perfect the provision of funds, follow through on commitment to hold allocation for due diligence research, whether Sponsor 50 frequently changes available allocation amount on a Deal 80, frequency of failing to meet fundraising targets, frequency of bringing Deals 80 to the table, communication response times, etc. Data tracked about Firm 40, Advisor 20, Client 30 preferably includes average hold request time for due diligence, frequency of commitment follow through after due diligence, average and/or total amount invested by Clients 30 in Deals 80 using the platform 10, time to perfect purchase and allocate portions to Clients 30, efforts in marketing Deals 80 to Clients 30, frequency of failing to satisfy commitments, pull outs, etc., communication with Clients 30 and with Sponsors 50 if unable to meet funding commitments.

The Reliability Score feature 180 also incorporates a proprietary standardizing factor 184 to reach a final, real-time Reliability Score 186 applicable to Clients 30, Advisors 20, Firms 40, Sponsors 50, CIOs 52, etc. The data considered in the proprietary standardizing factor 184 may include things like consistency, timeliness, investment amount/request, etc.

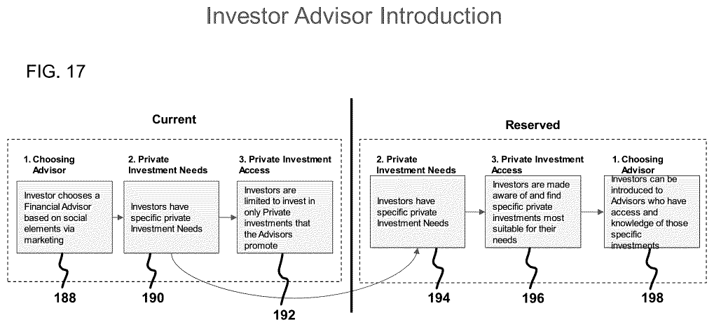

Referring to FIG. 17 now, preferable embodiments of the present invention 10 facilitate the relationship between investor/Client 30 and Advisor 20. In the past in private investments 18, the Advisor 20 relationship with Client 30 typically predates any actual investment activity, and potential opportunities would be brought to the Client 30 by the Advisor 20. The platform of the present invention 10 provides Clients 30 the opportunity to review and consider Deals 80 directly, in preferable embodiments, and even find an Advisor 20 qualified to advise on investments of the type the Client 30 is interested in.

More specifically, rather than beginning by selecting an Advisor 20 based on incomplete and often irrelevant information 188, providing that Advisor 20 with information about the Client's 30 investment goals, interests, etc. 190, and then awaiting Deals 80 presented by the Advisor 20, the Client 30 using the platform of the present invention 10 can start by identifying his or her own investment goals, interests, etc. 194, review investment opportunities available on the platform 10 that match those investment goals interests, etc. 196, and then identify an Advisor 20 with experience and expertise in those types of investment areas 198. This puts the power in the hands of the investor rather than relying on the Advisor 20, who has his or her own goals and motivations that do not necessarily align with those of the Client 30.

While the present invention has been described with reference to particular embodiments and arrangements of parts, features, and the like, it is not limited thereto. Indeed, modifications and the like will be ascertainable to those of skill in the art, all of which are inferentially and inherently included in these teachings.

What is claimed is:

1. A system for private investment, comprising:
one or more databases for storing information about private investment opportunities and about users of the system, said users comprising at least one of investors and potential investors, investment advisors, advisory firms, investment sponsors, and CIOs;
a GUI module for creation and display of a graphical user interface, the graphical user interface providing users access to information about the private investment opportunities stored in the one or more databases;
an analysis engine for assessing users and private investment opportunities, the analysis engine comprising:
a suitability module for assessing users, investment opportunity terms, and compatibility therebetween, the suitability module assessing whether a specific investment opportunity is appropriate for a specific user.

2. The system of claim 1, wherein the suitability module assesses investors and potential investors and applies a suitability score thereto based upon at least one of the following group of factors: individual's age, individual's geographic location, investment capital available, nature of investment accounts, financial goals and interests, familial considerations, investment experience, risk tolerance, investment timeline, liquidity requirements and any required minimum distributions, amount of available investment funds, current investment fund allocation, life goals.

3. The system of claim 1, wherein the suitability module assesses investment advisors and applies a suitability score thereto based upon at least one of the following group of factors: knowledge of, expertise in, and experience with types of investment opportunities, investment asset classes, and terms, years of advisor experience, number of investors advising, amount of investor funds advising, historical performance with private investments, and advisor's geographic location.

4. The system of claim 1, wherein the suitability module further comprises a suitability matrix that assigns a suitability score to each user corresponding to each private investment opportunity stored in the one or more databases, the suitability matrix assessing the suitability of each such private investment opportunity for investment by each investor and potential investor associated with each investment advisor and with each advisory firm.

5. The system of claim 4, wherein the suitability matrix assigns a suitability score for each combination of private investment opportunity, potential investor, and investment advisor.

6. The system of claim 5, wherein the suitability matrix arrives at said suitability score by iterating thousands of simulations to determine the most likely outcome associated with each combination of private investment opportunity, potential investor, and investment advisor.

7. The system of claim 6, wherein the suitability matrix comprises algorithmic machine learning and artificial intelligence features to improve the accuracy of said suitability score, said algorithmic machine learning and artificial intelligence features being capable of employing web scraping and other algorithmic learning techniques.

8. The system of claim 5, wherein the advisory firm can preclude associated investment advisors and potential investors from involvement with private investment opportunities for which said user's suitability score fails to reach a predetermined threshold.

9. The system of claim 5, wherein the investment sponsor associated with a private investment opportunity can alter terms of investment associated with the private investment opportunity in an attempt to improve the suitability score for each combination of potential investor and investment advisor with the private investment opportunity.

10. A system for private investment, comprising:
one or more databases for storing information about private investment opportunities and about users of the system, said users comprising at least one of investors and potential investors, investment advisors, advisory firms, investment sponsors, and CIOs;
a GUI module for creation and display of a graphical user interface, the graphical user interface providing users access to information about the private investment opportunities stored in the one or more databases;
an analysis engine for assessing users and private investment opportunities, the analysis engine comprising:
a reliability module that assigns a reliability score to at least one user, the reliability module assessing said user's reliability in connection with said user's association with private investment opportunities stored in the one or more databases.

11. The system of claim 10, wherein the reliability module assesses the at least one user and applies the reliability score thereto based upon at least one of the following group of factors: past tendencies in connection with private investment opportunities stored in the one or more databases; follow through on oral commitments and representations in connection with private investment opportunities stored in the one or more databases; follow through by investment sponsors in holding allocated funds during due diligence and document execution and finalization; amount of available investment funds; number and nature of associated investors and potential investors; investment experience; number and nature of sponsored private investment opportunities; diligence in earmarking investor funds, completing document execution, performing due diligence, and communication among investment advisor, potential investors, and investment sponsor; and consistency.

12. The system of claim 10, wherein the investment sponsor can preclude investors and potential investors, investment advisors, and advisory firms whose reliability score fails to reach a predetermined threshold from involvement with private investment opportunities sponsored by said investment sponsor.

13. The system of claim 10, wherein one or both of the investment advisor and the advisory firm can preclude investment in private investment opportunities associated with investment sponsors whose reliability score fails to reach a predetermined threshold.

14. The system of claim 10, wherein the reliability module comprises algorithmic machine learning and artificial intelligence features to improve the accuracy of said reliability score, said algorithmic machine learning and artificial intelligence features being capable of employing web scraping and other algorithmic learning techniques.

15. The system of claim 1, wherein the analysis engine further comprises a collaboration module, the collaboration module comprising social networking features permitting users to engage in one or more of following one another, joining groups, sharing information with users at large, with groups of users, or with individual users directly, engaging in direct communications using a messaging service, obtaining information about other individual users' private investment activities, and obtaining information about what other users are invested in a particular private investment opportunity.

16. The system of claim 1, wherein the analysis engine further comprises a collaboration module, the collaboration module comprising a negotiation platform comprising features for interaction among users to engage in one or more of altering terms associated with a private investment opportunity, requesting a hold of availability to perform due diligence, and requesting the removal of restrictions limiting a user's involvement with a private investment opportunity.

17. The system of claim 15, wherein the analysis engine further comprises a compensation module that facilitates financial compensation to users who engage in one or more of bringing new private investment opportunities to the attention of other users, sharing information relating to the user's private investment activities, and sharing due diligence performed in connection with private investment opportunities.

18. The system of claim 1, wherein the potential investors interested in investing in a private investment opportunity is directed to do so through investment advisors and advisory firms who have been granted authorization to said private investment opportunity.

19. The system of claim 1, wherein the analysis engine further comprises an audit module, the audit module accumulating and storing in the one or more databases information useful in managing an audit, such information including one or more of investor suitability reports, investment advisor suitability reports, internal due diligence and related processes, investor communications, subscription documents, and private investment opportunity disclosures and fee structures, the audit module further providing users with notifications of any inconsistencies associated with private investment opportunities or with information pertaining to investors and potential investors and investment advisors that might be significant in an audit.

20. A system for private investment, comprising:
one or more databases for storing information about private investment opportunities and about users of the system, said users comprising at least one of investors and potential investors, investment advisors, advisory firms, investment sponsors, and CIOs;
a GUI module for creation and display of a graphical user interface, the graphical user interface providing users access to information about other users and about the private investment opportunities stored in the one or more databases;
an analysis engine for assessing users and private investment opportunities, the analysis engine comprising:
a suitability module that assesses the suitability of each private investment opportunity for investment by each investor and potential investor associated with each investment advisor and with each advisory firm and assigns a suitability score for each combination of private investment opportunity, potential investor, and investment advisor by iterating thousands of simulations to determine the most likely outcome associated therewith;
the suitability module comprising algorithmic machine learning and artificial intelligence features to improve the accuracy of said suitability scores, said algorithmic machine learning and artificial intelligence features being capable of employing web scraping and other algorithmic learning techniques;
wherein the advisory firm can preclude associated investment advisors from involvement with private investment opportunities for which said investment advisor's suitability score fails to reach a predetermined threshold; and
wherein the investment sponsor associated with a private investment opportunity can alter terms of investment associated with the private investment opportunity in an attempt to improve the suitability score for each combination of potential investor and investment advisor with the private investment opportunity.

21. The system of claim 20, wherein the analysis engine further comprises a reliability module that assigns a reliability score to at least one user, the reliability module assessing the at least one user's reliability in connection with said user's association with private investment opportunities stored in the one or more databases;
the reliability module comprising algorithmic machine learning and artificial intelligence features to improve the accuracy of said reliability score, said algorithmic machine learning and artificial intelligence features being capable of employing web scraping and other algorithmic learning techniques;
wherein the advisory firm can preclude involvement with private investment opportunities associated with investment sponsors whose reliability score fails to reach a predetermined threshold; and
wherein the investment sponsor associated with a private investment opportunity can preclude investment by potential investors whose reliability score fails to reach a predetermined threshold and by potential investors associated with investment advisors or advisory firms whose reliability score fails to reach a predetermined threshold.

22. The system of claim 21, wherein the analysis engine further comprises a collaboration module, the collaboration module comprising:
social networking features permitting users to engage in one or more of following one another, joining groups, sharing information with users at large, with groups of users, or with individual users directly, engaging in direct communications using a messaging service, and obtaining information about other users' private investment activities;
a negotiation platform comprising features for interaction among users to engage in one or more of altering terms associated with a private investment opportunity, requesting a hold of availability to perform due diligence, and requesting the removal of restrictions limiting a user's involvement with a private investment opportunity.

23. The system of claim 22, wherein the analysis engine further comprises a compensation module that facilitates financial compensation to users who engage in one or more of bringing new private investment opportunities to the attention of other users, sharing information relating to the user's private investment activities, and sharing due diligence performed in connection with private investment opportunities.

24. They system of claim 23, wherein the analysis engine further comprises an audit module, the audit module accumulating and storing in the one or more databases information useful in managing an audit, such information including one or more of investor suitability reports, investment advisor suitability reports, internal due diligence and related processes, investor communications, subscription documents, and private investment opportunity disclosures and fee structures, the audit module further providing users with notifications of any inconsistencies associated with private investment opportunities or with information pertaining to investors and potential investors and investment advisors that might be significant in an audit.
